(19) United States
(12) Patent Application Publication
(10) Pub. No.: US 2017/0009520 A1
(43) Pub. Date: Jan. 12, 2017

(54) LOCKING DEVICE FOR WINDOW BLIND BETWEEN TWO PANES OF GLASS

(71) Applicant: Supreme Plastic Products Co., Ltd., Guangdong (CN)

(72) Inventor: SONG-LI ZHENG, Guangdong (CN)

(21) Appl. No.: 14/795,894

(22) Filed: Jul. 10, 2015

(51) Int. Cl. E06B 9/264; E06B 3/67; E06B 3/66

(52) U.S. Cl. CPC E06B 9/264; E06B 3/66; E06B 3/6722; E06B 2009/2646

(57) ABSTRACT

A locking device for window blind between two panes of glass is disclosed. The window blind is arranged between tow panes of glass through the attraction of the inside magnet and the outside magnet to transmit power to control the operation of the window blind. The locking device may achieve the effects of controlling smoothly and stopping firmly. The locking device may comprise a control shaft and a track. The control shaft includes a locking body, a switch, a hook, a spring, a bearing, and a magnet. The control shaft may be connected with the track through a hook position. The window blind is controlled by attraction of the inside magnet and the outside magnet to achieve the effects of control of raising and lowering the window blind between two panes of glass and light modulation. The locking device is controlled the engagement and disengagement between the hook and the track by the switch to ensure the window blind stopping at any position and without sliding down.

### FIELD OF THE INVENTION

The present invention relates to a locking device for window blind between two panes of glass.

### BACKGROUND OF THE INVENTION

The conventional window blind between two panes of glass is controlled by the attraction of the inside and outside magnets. The friction between the control shaft and the track and its own friction are controlled to lock the blades of the window blind to stop at appropriate position to prevent from sliding down. In order to prevent the blades of the window blind from sliding down, the only way is to increase pressure with increasing magnetic force between the inside magnet and the outside magnet to increase the friction. It is not only resulting in unnecessary waste, but also resulting in controlling the window blind unsmoothly.

Accordingly, the inventor of the present invention has devoted himself based on his many years of practical experiences to solve this problem.

### SUMMARY OF THE INVENTION

The primary object of the present invention is to provide a locking device for window blind between two panes of glass. The window blind is arranged between tow panes of glass through the attraction of the inside magnet and the outside magnet to transmit power to control the operation of the window blind. The locking device may achieve the effects of controlling smoothly and stopping firmly. The locking device may comprise a control shaft and a track. The control shaft includes a locking body, a switch, a hook, a spring, a bearing, and a magnet. The control shaft may be connected with the track through a hook position. The window blind is controlled by attraction of the inside magnet and the outside magnet to achieve the effects of control of raising and lowering the window blind between two panes of glass and light modulation. The locking device is controlled the engagement and disengagement between the hook and the track by the switch to ensure the window blind stopping at any position and without sliding down.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a perspective view of a window blind between two panes of glass according to present invention.

FIG. 2 is an exploded view of a locking device for window blind according to present invention.

FIG. 3 is an operational view of the locking device according to present invention.

FIG. 4 is an enlarged view of the locking device according to present invention while operating.

### DESCRIPTION OF THE PREFERRED EMBODIMENT

Referring now to the drawings where like characteristics and features among the various figures are denoted by like reference characters.

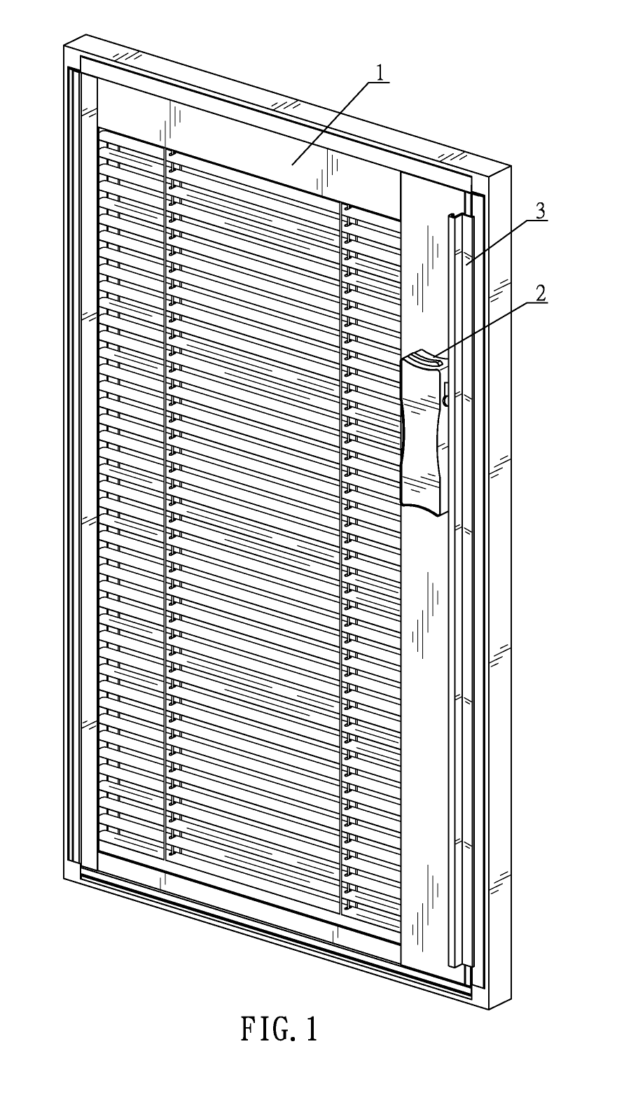

Please refer to FIG. 1, which shows a window blind arranged between two panes of glass. The window blind is arranged between two panes of glass. The window blind is controlled by attraction of the magnet mounted in the control shaft and the embedded magnet device to achieve the effects of control of raising and lowering the window blind between two panes of glass and light modulation. The objective of the track is to ensure the attraction of the magnet of the control shaft and the embedded magnet device at the best status to moving straightly and ensure that they are not come off easily.

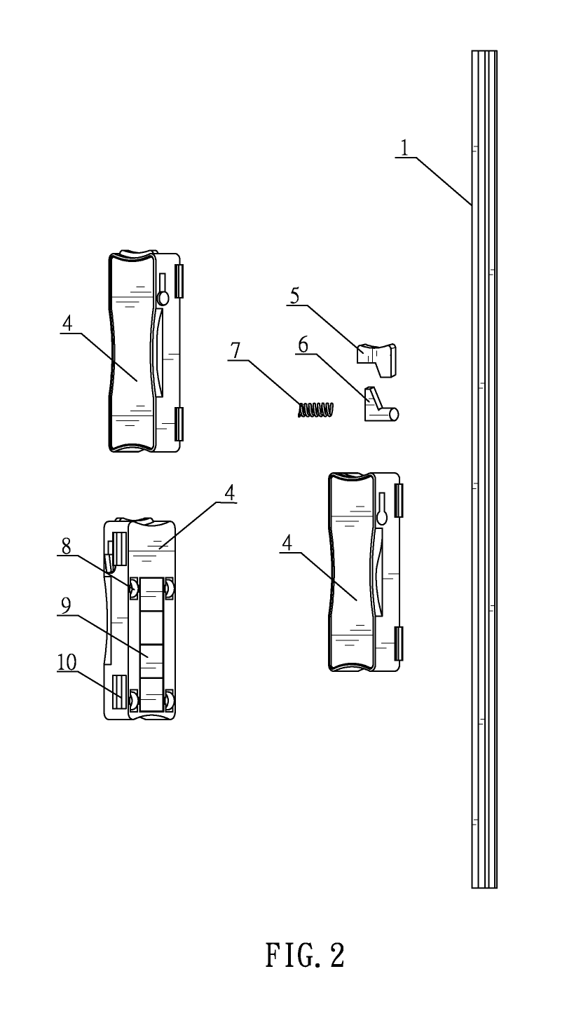

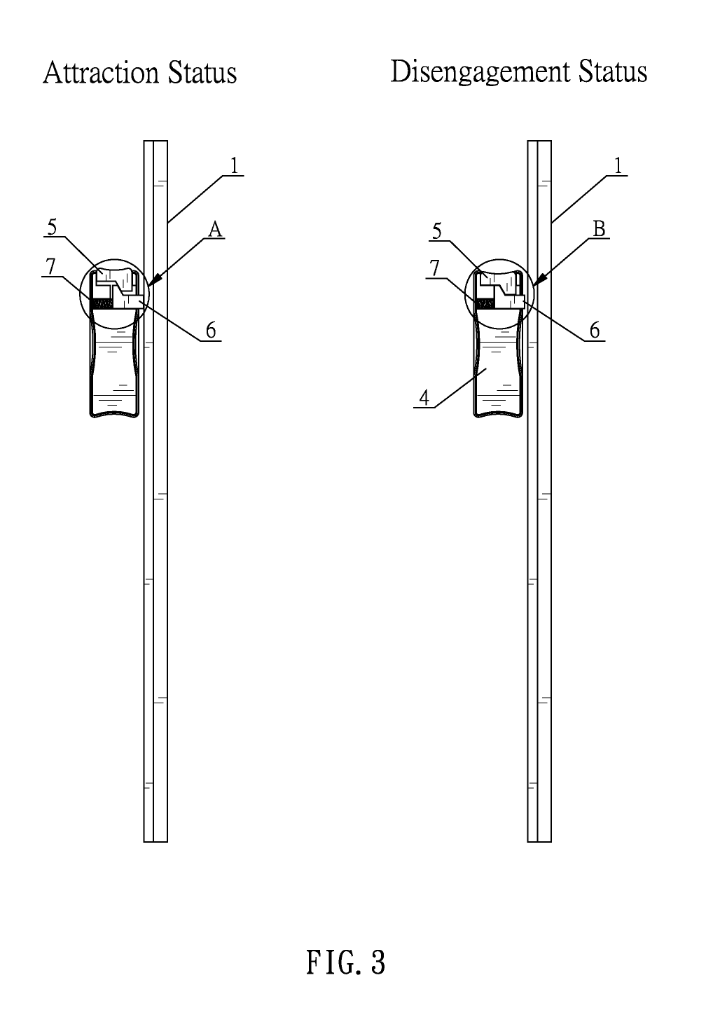

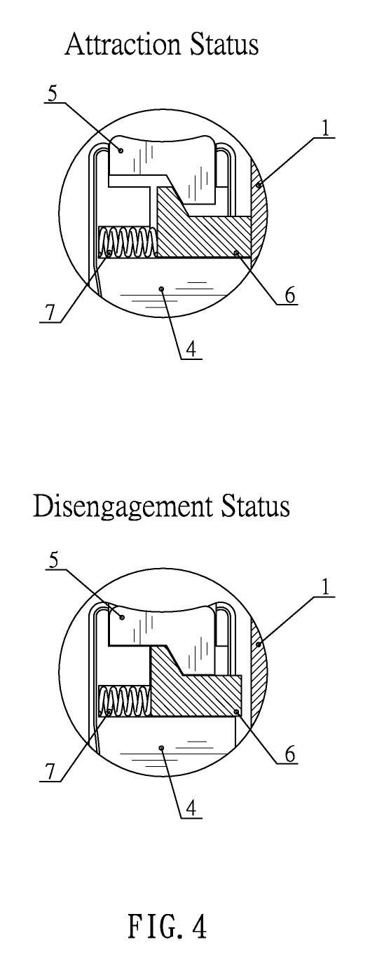

FIG. 2 is an exploded view of a locking device for window blind according to present invention. FIG. 3 is an operational view of the locking device according to present invention. FIG. 4 is an enlarged view of the locking device according to present invention while operating. The locking device comprising a control shaft 2 and a track 3. The control shaft 2 may include a locking body 4, a switch 5, a hook 6, a spring 7, a bearing 8, and a magnet 9. The control shaft 2 may be connected with the track 3 through a hook position 10. The window blind is controlled by attraction of the magnet 9 mounted in the control shaft 2 and the embedded magnet device to achieve the effects of control of raising and lowering the window blind between two panes of glass and light modulation. The bearing 8 may make the operation more smoothly. When the control shaft 2 is moved downwardly, the track 3 may be forced to the hook 6 due to the inclined design of the hook 6 and the track 3 and an angle of 1 degree is included between the direction of the force between the track 3 and the hook 6 and the moving direction of the hook 6. By the theorem of the direction of force, most force between the track 3 and the hook 6 is exerted at the moving direction of the hook 6. The track 3 is supplying a counter acting force to the hook 6 to push the hook 6 to move to the other side and press the spring 7, and then the hook 6 is moved and disengaged from the teeth of the track 3 to achieve the effects of moving the control shaft 2 downwardly and raising the window blind. When the control shaft 2 is stopped to move, the hook 6 is engaged with the teeth of the track 3 by the power of the spring 7 and the force between the track 3 and the hook 6 is downward and perpendicular to the moving direction of the hook 6. Because the force in the moving direction of the hook 6 is zero, the hook 6 may not be pushed to move. The control shaft 2 is hooked by the spring 7 so as to be engaged with the track 3 (shown as in FIGS. 3 and 4, in attraction status) to achieve the effect of locking the window blind at any position. When the window blind is lowered, the hook 6 is pushed inwardly by the switch 5 which is pressed down and the hook 6 is disengaged from the teeth of the track 3 (shown as in FIGS. 3 and 4, in disengagement status) to achieve the effect of lowering the window blind at will. The locking device is characterized as following. When the control shaft 2 is pressed down and the window blind is raised, the hand may be naturally touching the switch 5 and then the hook 6 is disengaged from a plurality of teeth of the track 3 so that the window blind is raised smoothly. When the control shaft 2 is released, the hook 6 is attracted to the track 3 by the spring 6 and the control shaft 2 is locked to stop the window blind.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A locking device for window blind between two panes of glass, characterized by smoothly releasing and firmly stopped through the locking device, the locking device comprising a control shaft and a track, wherein:
the control shaft includes a locking body, a switch, a hook, a spring, a bearing, and a magnet, the control shaft is connected with the track through a hook position;
when the control shaft is pressed down and the window blind is raised, the hand is naturally touching the switch and then the hook is disengaged from a plurality of teeth of the track so that the window blind is raised smoothly;
when the control shaft is released, the hook is attracted to the track by the spring and the control shaft is locked to stop the window blind;
when the control shaft is moved downwardly, the track is supplying a counter acting force to the hook by the theorem of the direction of force to push the hook to move to the other side and stride over the teeth of the track and then to control the control shaft to be lowered at will to raise the window blind;
when the control shaft is stopped to move, the hook is engaged and locked at the teeth of the track through the force of the spring; at this time, the track forces to the hook downwardly and is perpendicular to the moving direction of the hook so that the hook is not able to be pushed and the control shaft is firmly locked at the track to achieve the effect of locking the window blind at any position; and
when the window blind is lowered, the hook is pushed inwardly by the switch which is pressed down and the hook is disengaged from the teeth of the track to achieve the effect of lowering the window blind at will.
